(19) United States
(12) Patent Application Publication
(10) Pub. No.: US 2023/0267420 A1
(43) Pub. Date: Aug. 24, 2023

(54) DATA-PROCESSING METHOD

(71) Applicant: FUTURECITE INC., Edmonton (CA)

(72) Inventor: Eva Borsato, Edmonton (CA)

(73) Assignee: FUTURECITE INC., Edmonton, AB (CA)

(21) Appl. No.: 18/043,626

(22) PCT Filed: Aug. 31, 2021
(86) PCT No.: PCT/CA2021/051207

§ 371 Date: Mar. 1, 2023

(30) Foreign Application Priority Data
Sep. 1, 2020 (CA) 3091768

(51) Int. Cl. G06Q 10/1053

(52) U.S. Cl. CPC G06Q 10/1053

(57) ABSTRACT

A data-processing method involves: causing at least one computing device to receive at least one input signal representing at least a plurality of responses from at least one job applicant, each response of the plurality of responses being responsive to a respective prompt of a plurality of prompts, at least some responses of the plurality of responses selected from a plurality of selectable responses associated with the respective prompt; causing the at least one computing device to, responsive to at least some of the plurality of responses from the at least one job applicant, associate the at least one job applicant with a respective at least one job posting; and causing the at least one computing device to, responsive to at least some of the plurality of responses from the at least one job applicant, associate the at least one job applicant with a respective at least one learning opportunity.

### CROSS-REFERENCE TO RELATED APPLICATION

This application claims priority to Canadian patent application no. 3091768 filed on Sep. 1, 2020. The entire contents of Canadian patent application no. 3091768 are incorporated by reference herein.

### FIELD

This disclosure relates generally to data processing, for example to associate one or more job applicants with one or more job postings and with one or more learning opportunities.

### RELATED ART

Improving and using the potential of individuals can be important, particularly in modern economies. However, existing data-processing methods may not sufficiently facilitate improving or using the potential of individuals. Existing data-processing methods have traditionally focused on industry-sector specialization, thereby limiting access by individuals to improve their potential across more than one industry sector. Also, existing data-processing methods have focused on either job postings or education course postings, leaving individuals limited access to opportunities in modern economies.

Also, existing data-processing methods can be inefficient.

### SUMMARY

According to at least one embodiment, there is disclosed a data-processing method comprising: causing at least one computing device to receive at least one input signal representing at least a plurality of responses from at least one job applicant, each response of the plurality of responses being responsive to a respective prompt of a plurality of prompts, at least some responses of the plurality of responses selected from a plurality of selectable responses associated with the respective prompt; causing the at least one computing device to, responsive to at least some of the plurality of responses from the at least one job applicant, associate the at least one job applicant with a respective at least one job posting; and causing the at least one computing device to, responsive to at least some of the plurality of responses from the at least one job applicant, associate the at least one job applicant with a respective at least one learning opportunity.

In some embodiments, the method further comprises causing the at least one computing device to cause at least some of the plurality of prompts to be presented to the at least one job applicant.

In some embodiments, the method further comprises causing the at least one computing device to, responsive to at least some of the plurality of responses from the at least one job applicant, associate the at least one job applicant with a respective at least one potential association of a plurality of potential associations.

In some embodiments, causing the at least one computing device to associate the at least one job applicant with the respective at least one potential association comprises causing the at least one computing device to determine a respective degree of association of the at least one job applicant with each potential association of the respective at least one potential association.

In some embodiments, causing the at least one computing device to determine the respective degree of association of the at least one job applicant with each potential association of the respective at least one potential association comprises causing the at least one computing device to determine the respective degree of association of the at least one job applicant with each potential association of the respective at least one potential association responsive to at least a count of the plurality of responses from the at least one job applicant that are positively associated with the potential association.

In some embodiments, causing the at least one computing device to determine the respective degree of association of the at least one job applicant with each potential association of the respective at least one potential association comprises causing the at least one computing device to determine the respective degree of association of the at least one job applicant with each potential association of the respective at least one potential association responsive to at least a count of the plurality of responses from the at least one job applicant that are negatively associated with the potential association.

In some embodiments, the method further comprises causing the at least one computing device to determine a degree of similarity of the respective at least one potential association associated with the at least one job applicant with a respective at least one potential association of the plurality of potential associations and associated with the at least one job posting. In some embodiments, causing the at least one computing device to associate the at least one job applicant with the at least one job posting comprises causing the at least one computing device to associate the at least one job applicant with the at least one job posting responsive to at least the degree of similarity of the respective at least one potential association associated with the at least one job applicant with the respective at least one potential association associated with the at least one job posting.

In some embodiments, causing the at least one computing device to determine the degree of similarity of the respective at least one potential association associated with the at least one job applicant with the respective at least one potential association associated with the at least one job posting comprises causing the at least one computing device to determine the degree of similarity of the respective at least one potential association associated with the at least one job applicant with the respective at least one potential association associated with the at least one job posting comprises responsive to each respective degree of association of the at least one job applicant with the respective at least one potential association associated with the at least one job posting.

In some embodiments, causing the at least one computing device to associate the at least one job applicant with the at least one job posting comprises causing the at least one computing device to rank a plurality of job applicants comprising the at least one job applicant in association with the at least one job posting according to the respective degrees of similarity.

In some embodiments, causing the at least one computing device to associate the at least one job applicant with the at least one job posting comprises causing the at least one computing device to rank a plurality of job postings comprising the at least one job posting in association with the at least one job applicant according to the respective degrees of similarity.

In some embodiments, the method further comprises causing the at least one computing device to determine a degree of similarity of the respective at least one potential association associated with the at least one job applicant with a respective at least one potential association of the plurality of potential associations and associated with the at least one learning opportunity. In some embodiments, causing the at least one computing device to associate the at least one job applicant with the at least one learning opportunity comprises causing the at least one computing device to associate the at least one job applicant with the at least one learning opportunity responsive to at least the degree of similarity of the respective at least one potential association associated with the at least one job applicant with the respective at least one potential association associated with the at least one learning opportunity. In some embodiments, causing the at least one computing device to determine the degree of similarity of the respective at least one potential association associated with the at least one job applicant with the respective at least one potential association associated with the at least one learning opportunity comprises causing the at least one computing device to determine the degree of similarity of the respective at least one potential association associated with the at least one job applicant with the respective at least one potential association associated with the at least one learning opportunity comprises responsive to each respective degree of association of the at least one job applicant with the respective at least one potential association associated with the at least one learning opportunity.

In some embodiments, causing the at least one computing device to associate the at least one job applicant with the at least one learning opportunity comprises causing the at least one computing device to rank a plurality of job applicants comprising the at least one job applicant in association with the at least one learning opportunity according to the respective degrees of similarity.

In some embodiments, causing the at least one computing device to associate the at least one job applicant with the at least one learning opportunity comprises causing the at least one computing device to rank a plurality of learning opportunities comprising the at least one learning opportunity in association with the at least one job applicant according to the respective degrees of similarity.

In some embodiments, the method further comprises causing the at least one computing device receive at least one input signal representing a contribution, by the at least one job applicant, of at least one new potential association to the plurality of potential associations.

In some embodiments, the method further comprises causing the at least one computing device receive at least one input signal representing a contribution, by at least one employer, of at least one new potential association to the plurality of potential associations.

In some embodiments, the method further comprises causing the at least one computing device receive at least one input signal representing a contribution, by at least one learning institution, of at least one new potential association to the plurality of potential associations.

In some embodiments, the method further comprises causing the at least one computing device receive at least one input signal representing a contribution, by at least one educator, of at least one new potential association to the plurality of potential associations.

In some embodiments, at least some of the plurality of potential associations are associated with respective different industry job trends.

In some embodiments, at least some of the plurality of potential associations are associated with respective different industry job sectors.

In some embodiments, at least some of the plurality of potential associations are associated with respective different occupations.

In some embodiments, at least some of the plurality of potential associations are associated with respective different employment benefits.

In some embodiments, at least some of the plurality of potential associations are associated with respective different skills.

In some embodiments, at least some of the plurality of potential associations are associated with respective social attributes.

In some embodiments, at least some of the plurality of potential associations are associated with respective social capabilities.

In some embodiments, at least some of the plurality of plurality of learning opportunities are respective different learning institutions.

In some embodiments, at least some of the learning institutions are provided independently from a provider of the method.

In some embodiments, at least some of the plurality of plurality of learning opportunities are respective different educators.

In some embodiments, at least some of the educators are independent from a provider of the method.

In some embodiments, at least some of the plurality of plurality of learning opportunities are respective different learning courses.

In some embodiments, at least some of the plurality of plurality of learning opportunities are respective different learning programs of respective pluralities of learning courses.

In some embodiments, at least some of the plurality of plurality of learning opportunities are respective different electronic media resources.

In some embodiments, at least some of the learning courses are provided independently from a provider of the method.

In some embodiments, at least some of the learning courses are provided by a provider of the method.

In some embodiments, causing the at least one computing device to associate the at least one job applicant with the respective at least one job posting comprises causing the at least one computing device to associate the at least one job applicant with the respective at least one job posting according to at least a machine-learning algorithm.

In some embodiments, causing the at least one computing device to associate the at least one job applicant with the respective at least one learning opportunity comprises causing the at least one computing device to associate the at least one job applicant with the respective at least one learning opportunity according to at least a machine-learning algorithm.

In some embodiments, the method further comprises causing the at least one computing device to produce at least one output signal responsive to association of the at least one job applicant with the respective at least one job posting.

In some embodiments, the method further comprises causing the at least one computing device to produce at least one output signal responsive to association of the at least one job applicant with the respective at least one learning opportunity.

In some embodiments, the method further comprises causing at least one user device to transmit the at least one input signal to the at least one computing device.

According to at least one embodiment, there is disclosed at least one computer-readable medium storing thereon program codes that, when executed by at least one processor, cause the at least one processor to implement the method.

According to at least one embodiment, there is disclosed at least one computing device programmed to implement the method.

In some embodiments, the at least one computing device is or comprises a personal computer.

In some embodiments, the at least one computing device is or comprises a laptop.

In some embodiments, the at least one computing device is or comprises a tablet computer.

In some embodiments, the at least one computing device is or comprises a smartphone.

In some embodiments, the at least one computing device is or comprises a smart watch.

In some embodiments, the at least one computing device is or comprises glasses.

In some embodiments, the at least one computing device is or comprises a mobile activity tracker.

In some embodiments, the at least one computing device is or comprises a wearable activity tracker.

In some embodiments, the at least one computing device is or comprises a haptic glove.

In some embodiments, the at least one computing device comprises at least one sensor wearable on a body and operable to measure movement of the body.

Other aspects and features will become apparent to those ordinarily skilled in the art upon review of the following description of illustrative embodiments in conjunction with the accompanying figures.

### BRIEF DESCRIPTION OF THE DRAWINGS

FIG. 1 illustrates a data-processing system according to one embodiment.

FIG. 2 illustrates a processor circuit of a server computing device of the data-processing system of FIG. 1.

FIG. 3 illustrates an example of a user interface of a user computing device of the data-processing system of FIG. 1.

FIG. 4 illustrates a prompts and selectable responses table entry of a prompts and selectable responses store of the processor circuit of FIG. 2.

FIG. 5 to FIG. 11 illustrate examples of prompts on the user interface of FIG. 3.

FIG. 12, FIG. 13, FIG. 14A, and FIG. 14B illustrate other examples of the user interface of FIG. 3.

### DETAILED DESCRIPTION

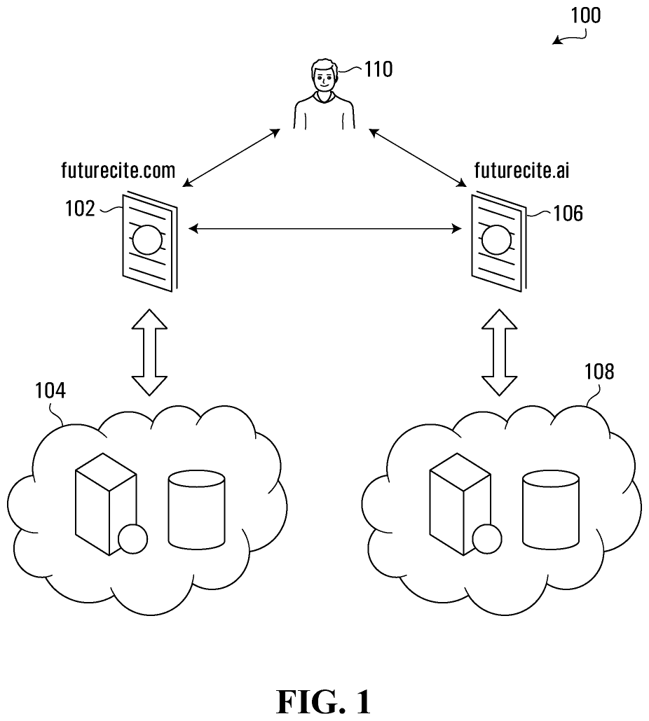

Referring to FIG. 1, a data-processing system according to one embodiment is shown generally at 100 and includes a user computing device 102 and a server computing device 104 operable to communicate with the user computing device 102. The system 100 also includes a user computing device 106 and a server computing device 108 operable to communicate with the user computing device 106. The user computing device 102 and the user computing device 106 may be a personal computer, a laptop, a tablet computer, a smartphone, a smart watch, glasses, a mobile or a wearable activity tracker bearing electronic sensors (that may measure body movement) or multifunctional electronic circuit assemblies wearable or worn on the body, a haptic glove, or another computing device that includes one or more user input devices and one or more user output devices, and that is operable to provide an interactive user interface (such as an interactive user interface using a web page or an app, for example) on one or more output devices (such as a display screen or a video projector, for example) with a user 110 as described herein, for example. The user computing device 106 may be similar to the user computing device 102, and the server computing device 108 may be similar to the server computing device 104. However, alternative embodiments may differ. For example, in some embodiments, one server computing device may implement some or all of the functionality of the server computing devices 104 and 108, or one or more different server computing devices may individually or collectively implement some or all of the functionality of the server computing devices 104 and 108.

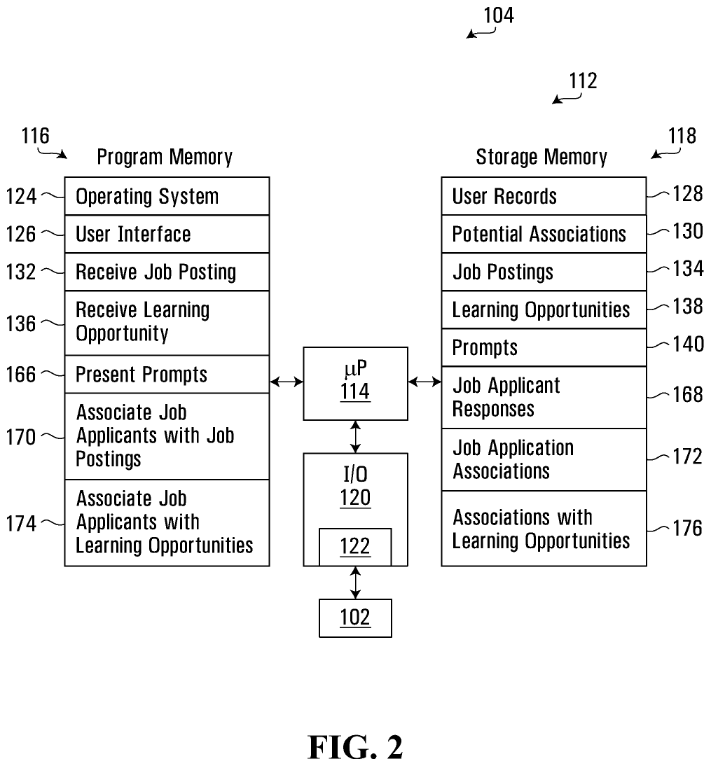

Referring to FIG. 2, the server computing device 104 includes a processor circuit shown generally at 112. The processor circuit 112 includes a central processing unit (“CPU”) or microprocessor 114. The processor circuit 112 also includes a program memory 116, a storage memory 118, and an input/output (“I/O”) module 120 all in communication with the microprocessor 114. In general, the program memory 116 stores program codes that, when executed by the microprocessor 114, cause the processor circuit 112 to implement functions of the server computing device 104 such as those described herein, for example. Further, in general, the storage memory 118 includes stores for storing storage codes as described herein, for example. The storage memory 118 may store entries in tables of a relational database, for example. The program memory 116 and the storage memory 118 may be implemented in one or more of the same or different computer-readable storage media, which in various embodiments may include one or more of a read-only memory (“ROM”), random access memory (“RAM”), a hard disc drive (“HDD”), a solid-state drive (“SSD”), and other computer-readable and/or computer-writable storage media.

The I/O module 120 may include various signal interfaces, analog-to-digital converters (“ADCs”), receivers, transmitters, and/or other circuitry to receive, produce, and transmit signals as described herein, for example. In the embodiment shown, the I/O module 120 includes a network interface 122 for transmitting signals to, and receiving signals from, the user computing device 102 using one or more networks such as the Internet, one or more wired networks, one or more wireless networks, or a combination of two or more thereof, for example.

The program memory 116 includes operating system program codes 124 of an operating system. The program memory 116 includes user interface program codes 126 that, when executed by the microprocessor 114, cause the processor circuit 112 to control an interactive user interface of the user computing device 102 by causing the network interface 122 to receive signals from the user computing device 102, and by causing the network interface 122 to transmit signals to the computing device 102. For example, if the user computing device 102 provides an interactive user interface using a web page, then the user interface program codes 126, when executed by the microprocessor 114, may cause the network interface 122 to transmit to the computing device 102 signals representing hypertext markup language (“HTML”) codes, JavaScript™ codes, or other codes that may control the interactive user interface, and may cause the network interface 122 to receive signals from the user computing device 102 representing user input in the interactive user interface.

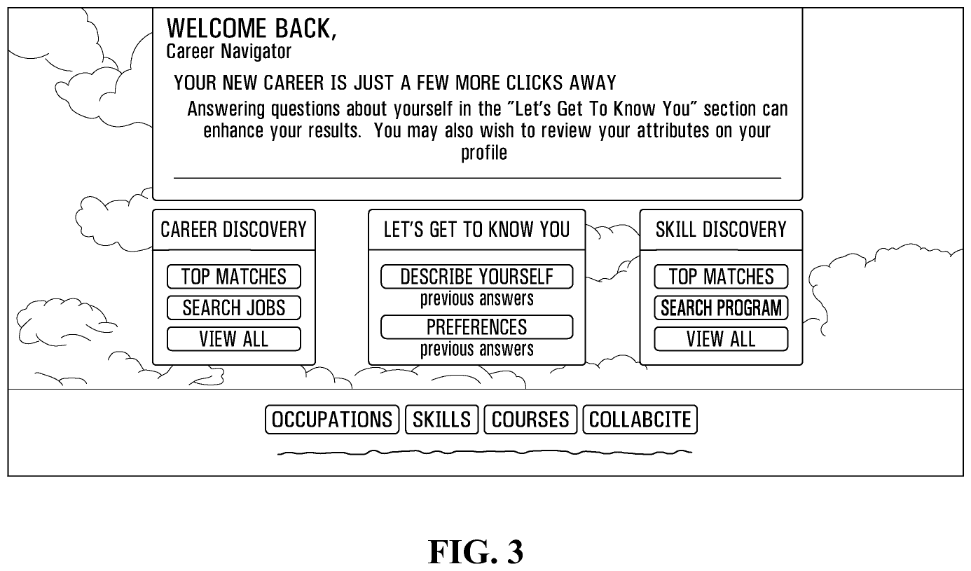

An example of a user interface of the user computing device 102, on a display screen, a video projector, or another output device of the user computing device 102, in response to the user interface program codes 126, when executed by the microprocessor 114, is shown in FIG. 3.

In general, various users (such as job applicants, employers, learning institutions, and educators, for example) may use such an interactive user interface to establish user accounts, and storage codes representing details of such user accounts (such as usernames, passwords, and other user details) may be stored in a user records store 128 in the storage memory 118 shown in FIG. 2.

Referring back to FIG. 2, the storage memory 118 may also include a potential associations store 130 storing representations of potential associations. In general, a potential association may indicate a trait, characteristic, attribute, or other potential association with a potential job posting or with a potential learning opportunity, and a job applicant may be associated with a potential association if the job applicant appears to possess an interest in, aptitude for, resemblance to, possession of, or other association with the potential association. For example, some potential associations may each represent different industry job trends (such as technology consumer goods, for example), some potential associations may each represent different industry job sectors (such as technology, communications, and entertainment as one industry job sector, for example), some potential associations may each represent different occupations (such as managers and executives as one occupation, carpenters as another occupation, or electricians as another occupation, for example), some potential associations may each represent different employment benefits (such as an extended health plan, for example), some potential associations may each represent different skills (such as time management, for example), some potential associations may each represent different social attributes (such as different Meyers-Briggs personality types, for example), and some potential associations may each represent different social capabilities (such as active listener, for example).

As indicated above, some users may be employers. The program memory 116 may include receive job posting program codes 132 that, when executed by the microprocessor 114, cause the processor circuit 112 to control an interactive user interface of a user computing device (such as the user computing device 102 or 106) that allows an employer user to post a job posting by providing various details of the job posting such as a job description, a location of the job (if any), and an identification of one or more potential associations that are desirable for job applicants for the job posting (so that such one or more potential associations may be associated with the job posting). Representations of such details of job postings may be stored in a job postings store 134 in the storage memory 118.

Likewise, as indicated above, some users may be learning institutions or educators, and such learning institutions or educators may include publicly funded learning institutions or educators, privately funded learning institutions or educators, or both. The program memory 116 may include receive learning opportunity program codes 136 that, when executed by the microprocessor 114, cause the processor circuit 112 to control an interactive user interface of a user computing device (such as the user computing device 102 or 106) that allows a learning institution or educator user to post a learning opportunity by providing various details of the learning opportunity. Such a learning opportunity may be posted to, and made available from, one or both of the server computing devices 104 and 108 or one or more different server computing devices that may individually or collectively implement some or all of the functionality of the server computing devices 104 and 108. A learning opportunity may be a learning institution or educator, a learning course, or a learning program including more than one learning course, and a learning course may be part or all of a formal course or may include one or more electronic media resources (or stories) such as videos, podcasts, written articles, or webinars. One or more hashtags may be associated with one or more of such electronic media resources. When a learning opportunity is a learning institution or educator, the details may include a description of the learning institution or educator and an identification of one or more potential associations that identify a likely benefit from the learning institution or educator. When a learning opportunity is a learning course, or a learning program including more than one learning course, the details may include a description of the learning course or learning program and an identification of one or more potential associations that identify a likely benefit from the learning course or learning program. Representations of such details of learning opportunities may be stored in a learning opportunities store 138 in the storage memory 118.

In general, learning institutions or educators as described herein may be independent of a provider of embodiments such as those described herein. For example, a business, group or business, or other entity or entities may provide one or more server computing devices such as the server computing device 104 or the server computing device 108 for example, and may provide applications or other program codes for user computing devices such as the user computing device 102 or the user computing device 106 for example. Such a business, group or business, other entity or entities, or other provider of such one or more server computing devices or such applications or other program codes for user computing devices may be referred to as a provider of embodiments such as those described herein. One or more learning institutions or educators as described herein may be independent of such a provider of embodiments such as those described herein and may, for example, be universities, colleges, other educators, educational institutions, or educational service providers that are legally distinct, unaffiliated, or otherwise independent of such a provider of embodiments such as those described herein.

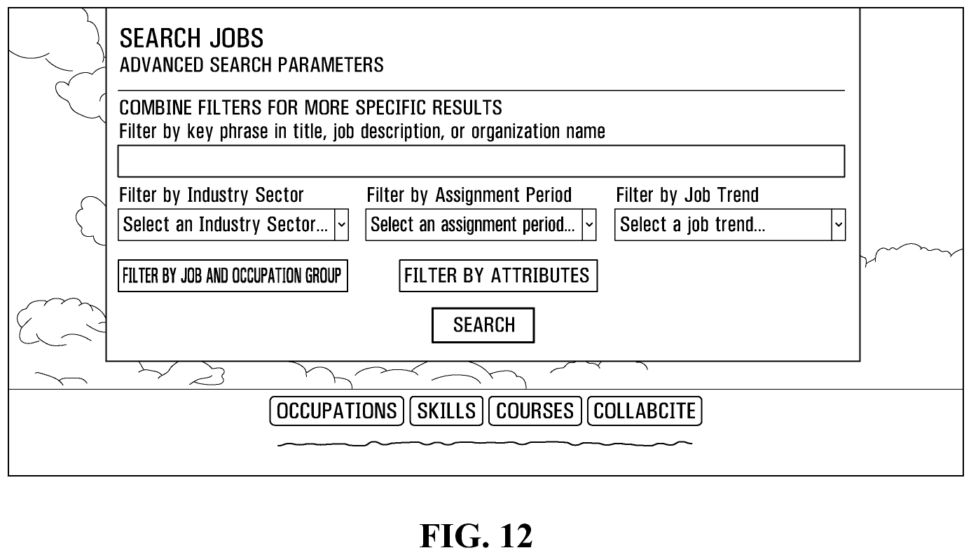

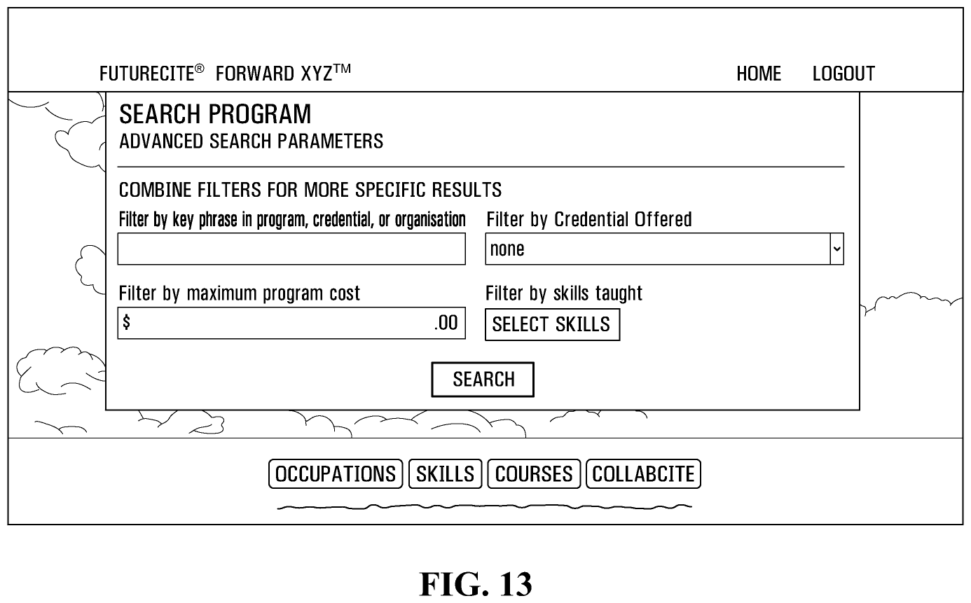

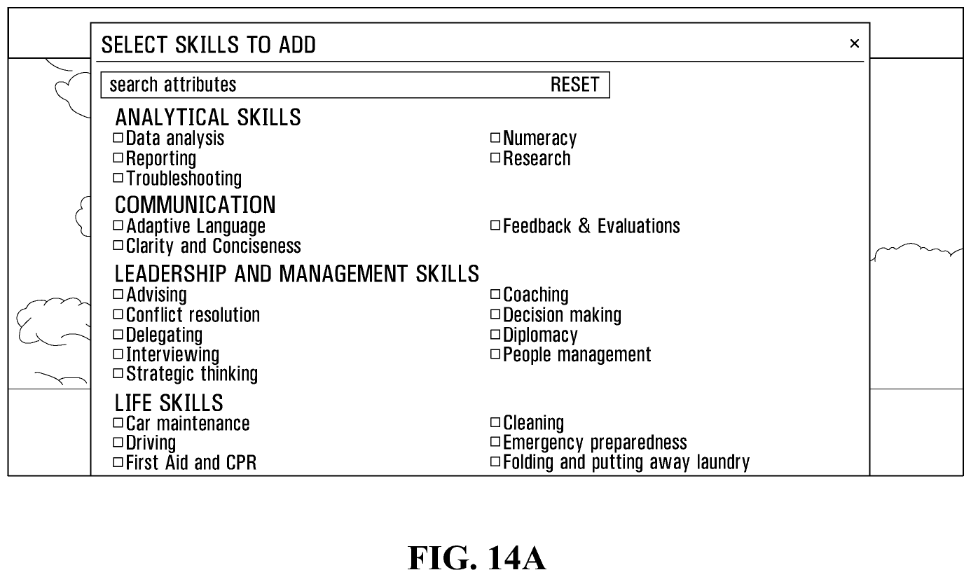

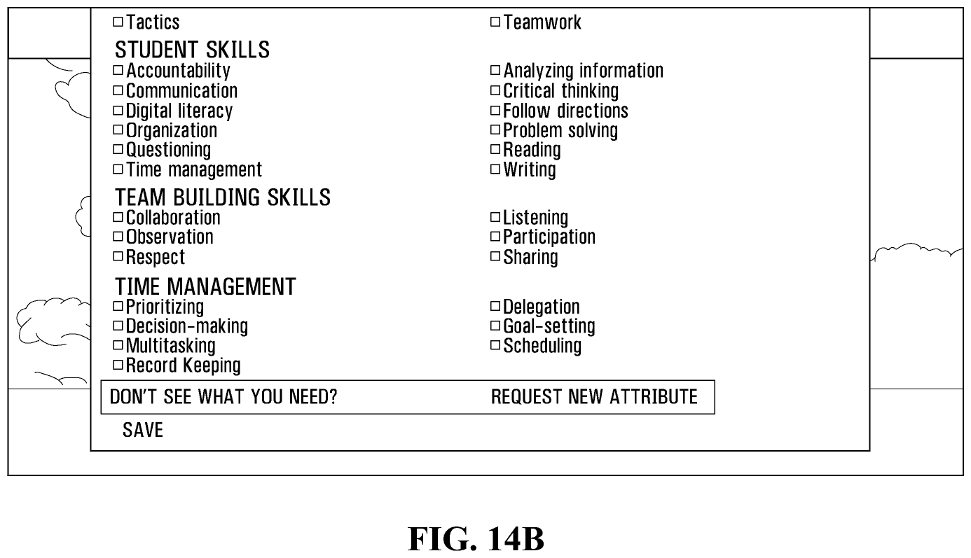

However, in some embodiments, a provider of embodiments such as those described herein (such as a provider of one or more methods such as those described herein, for example) may also be a learning institution or educator as described herein and may provide one or more learning courses as described herein. For example, a provider of embodiments such as those described herein may provide links (such as links shown for “OCCUPATIONS”, “SKILLS”, “COURSES”, and “COLLABCITE” in FIG. 12 and FIG. 13) to one or more learning courses such as one or more electronic media resources as described above, for example, and providing one or more learning courses may involve providing such links.

The storage memory 118 may also include a prompts and selectable responses store 140 storing representations of prompts. In general, each prompt may be a question that can be posed to a job applicant and that may facilitate determining the suitability of the job applicant for one or more job postings (such as a job posting having details stored in the job postings store 134), for one or more learning opportunities (such as a learning opportunity having details stored in the learning opportunities store 138), or for both, for example.

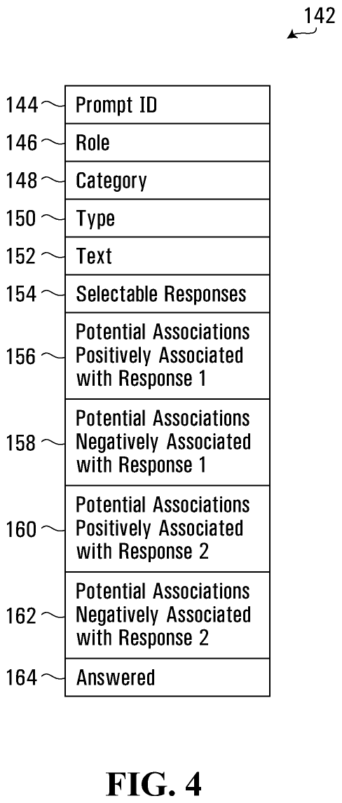

The prompts and selectable responses store 140 may include a table that may store any number of instances of a prompts and selectable responses table entry shown generally at 142 in FIG. 4. In general, the prompts and selectable responses table entry 142 may include various fields as described below. Each instance of the prompts and selectable responses table entry 142 may be associated with a respective prompt and can store, in such fields, particular values associated with the respective prompt.

The prompts and selectable responses table entry 142 includes a prompt identifier field 144, which stores an integer that may be assigned by database management system (“DBMS”) codes to identify an instance of the prompts and selectable responses table entry 142 uniquely in the prompts and selectable responses store 140 (shown in FIG. 3).

The prompts and selectable responses table entry 142 also includes a role field 146 that may store a representation of a role or type of user, such as a representation of job applicants, a representation of employers, or a representation of learning institutions or educators, for example. As a result, data in the role field 146 of an instance of the prompts and selectable responses table entry 142 may indicate that a prompt associated with an instance of the prompts and selectable responses table entry 142 is intended to be asked of a particular type of user, such as a job applicant, an employer, a learning institution, or an educator, for example.

The prompts and selectable responses table entry 142 also includes a category field 148 that may store a representation of a category of a prompt associated with an instance of the prompts and selectable responses table entry 142.

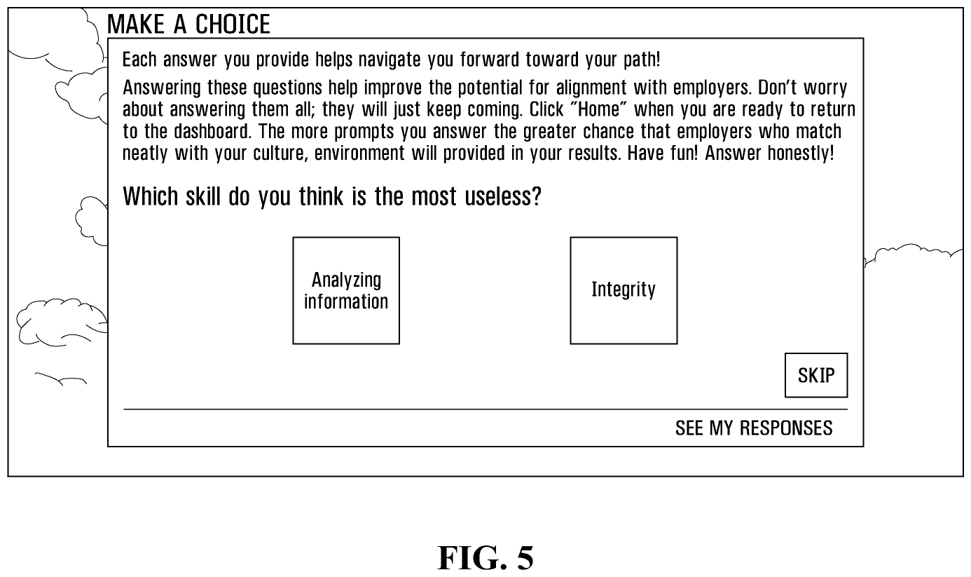

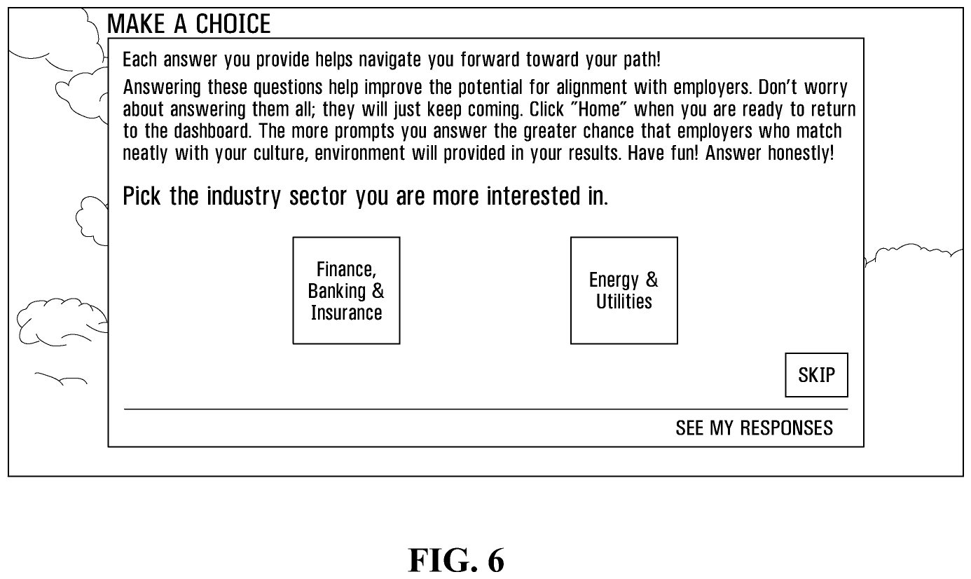

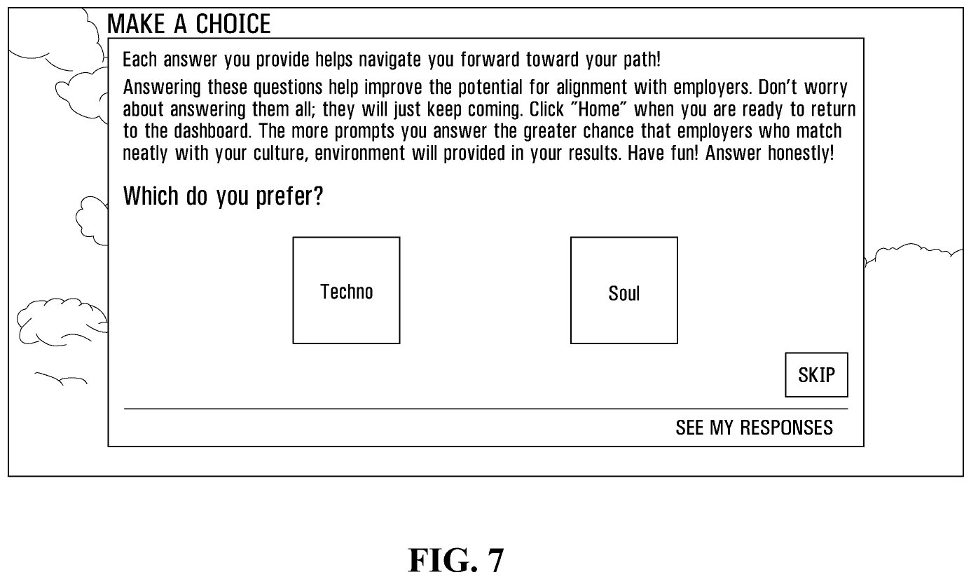

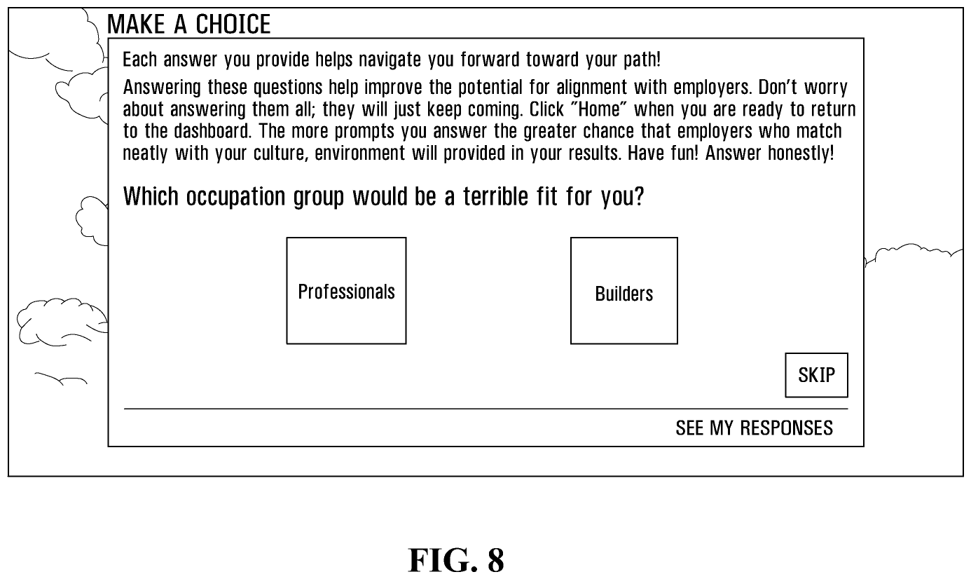

For example, some prompts may be associated with a respective two or more selectable responses, and such prompts may be in a category of prompts that are associated with a respective two or more selectable responses. Examples of prompts that are associated with a respective two or more selectable responses are shown in FIG. 5 to FIG. 8. Those examples include prompts that are associated with two selectable responses, or an option to skip the prompt by not answering the prompt. For example, as shown in FIG. 5, a prompt “Which skill do you think is the most useless?” may be associated with two selectable responses, namely “Analyzing information” and “Integrity”. As another example, as shown in FIG. 6, a prompt “Pick the industry sector you are more interested in.” may be associated with two selectable responses, namely “Finance, Banking & Insurance” and “Energy & Utilities”. As another example, as shown in FIG. 7, a prompt “Which do you prefer?” may be associated with two selectable responses, namely “Techno” and “Soul”. As another example, as shown in FIG. 8, a prompt “Which occupation would be a terrible fit for you?” may be associated with two selectable responses, namely “Professionals” and “Builders”. However, other prompts may include more than two selectable responses. For example, a prompt “Are you interested in construction?” may be associated with two selectable responses, namely “Yes” and “No”, or may be associated with three selectable responses, namely “Yes”, “No”, and “Neutral”.

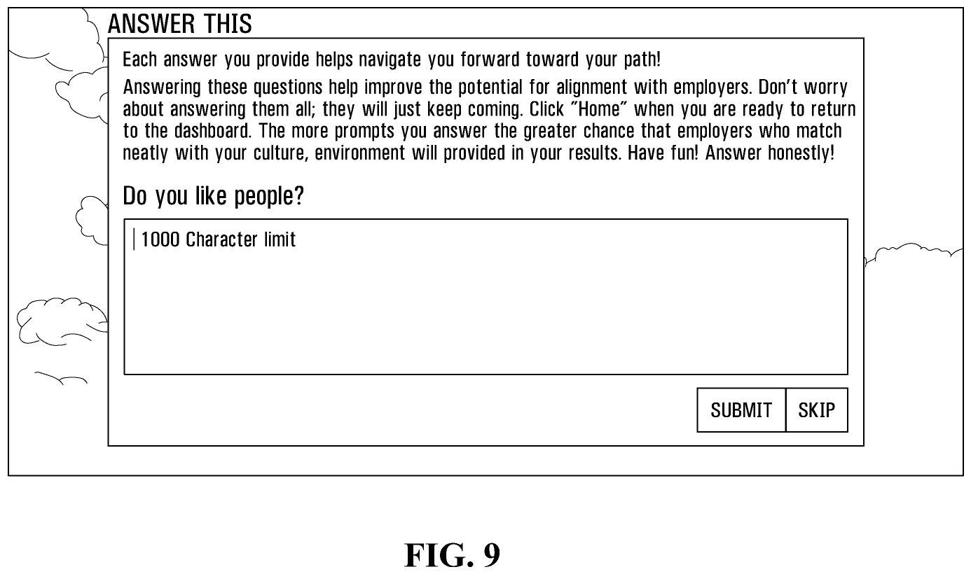

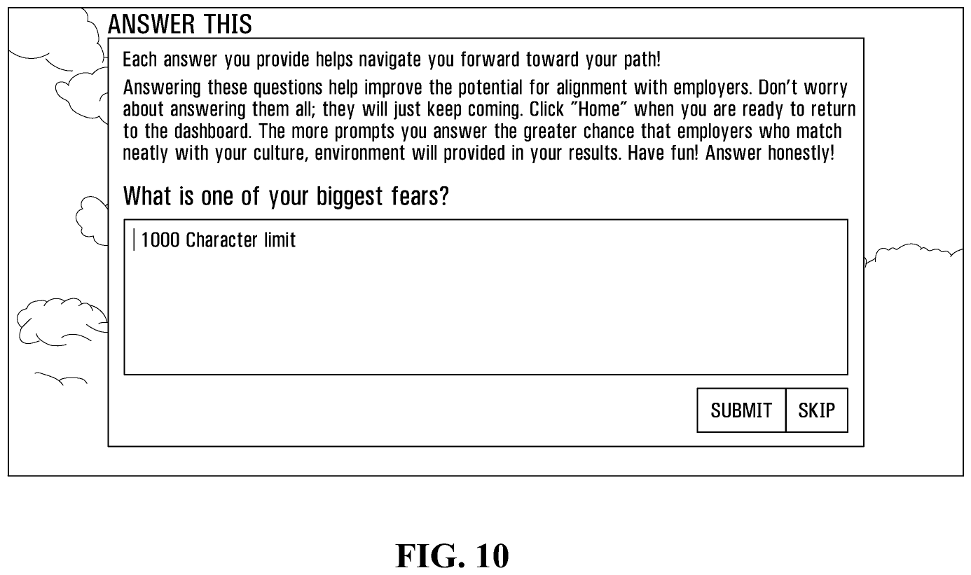

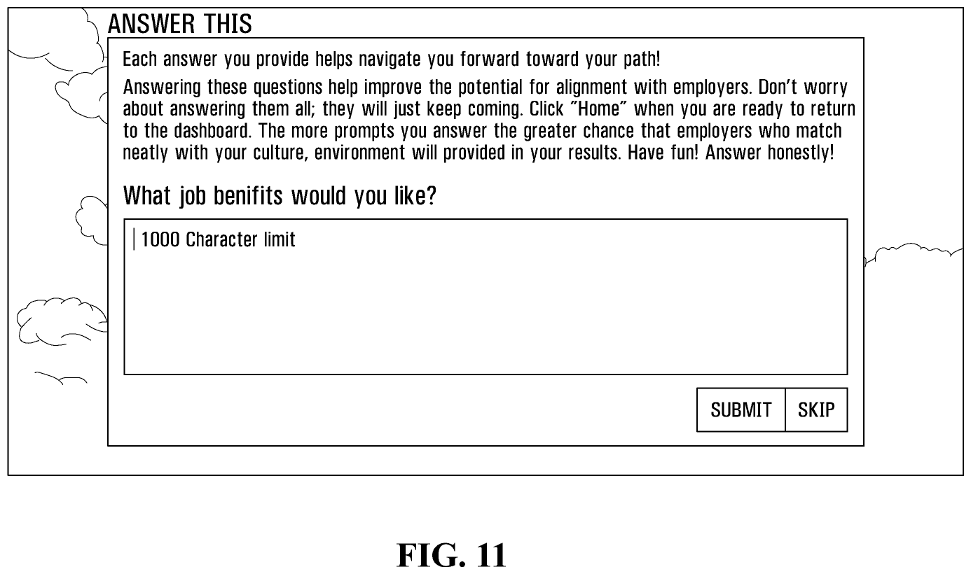

However, some other prompts may not be associated with a respective two or more selectable responses, and may instead allow a respondent to fill in a blank space. Such prompts may be in a category of prompts that are not associated with a respective two or more selectable responses but that rather allow a respondent to fill in a blank space. Examples of prompts that allow a respondent to fill in a blank space are shown in FIG. 9 to FIG. 11. For example, as shown in FIG. 9, a prompt may be “Do you like people?”. As another example, as shown in FIG. 10, a prompt may be “What is one of your biggest fears?”. As another example, as shown in FIG. 11, a prompt may be “What job benefits would you like?”.

Referring back to FIG. 4, the prompts and selectable responses table entry 142 also includes a type field 150 that may store a representation of a type of a prompt associated with an instance of the prompts and selectable responses table entry 142. A type may be positive (such as “Pick the industry sector you are more interested in.” in the example of FIG. 6 or “What job benefits would you like?” in the example of FIG. 11) or negative (such as “Which skill do you think is the most useless?” in the example of FIG. 5 or “Which occupation would be a terrible fit for you?” in the example of FIG. 8).

The prompts and selectable responses table entry 142 also includes a text field 152 that may store a representation of text of a prompt associated with an instance of the prompts and selectable responses table entry 142 (such as “Which skill do you think is the most useless?” in the example of FIG. 5 or “Do you like people?” in the example of FIG. 9).

The prompts and selectable responses table entry 142 also includes a selectable responses field 154 that may store representations of selectable responses (such as “Analyzing information” and “Integrity” in the example of FIG. 5 or “Techno” and “Soul” in the example of FIG. 7) associated with a prompt associated with an instance of the prompts and selectable responses table entry 142.

The prompts and selectable responses table entry 142 also includes a potential associations positively associated with response 1 field 156 that may store representations of any potential associations (stored in the potential associations store 130) that may be positively associated with a first selectable response to a prompt associated with an instance of the prompts and selectable responses table entry 142. For example, in the example of FIG. 6, “Finance, Banking & Insurance” may be a first selectable response, and a respondent who chooses “Finance, Banking & Insurance” over “Energy & Utilities” may be positively associated with potential associations such as “analytical” and “office jobs”. Therefore, in an instance of the prompts and selectable responses table entry 142 associated with the prompt “Pick the industry sector you are more interested in.” as shown in FIG. 6, the potential associations positively associated with response 1 field 156 may store representations of potential associations “analytical” and “office jobs”.

The prompts and selectable responses table entry 142 also includes a potential associations negatively associated with response 1 field 158 that may store representations of any potential associations (stored in the potential associations store 130) that may be negatively associated with a first selectable response to a prompt associated with an instance of the prompts and selectable responses table entry 142. For example, in the example of FIG. 8, “Professionals” may be a first selectable response in response to the prompt “Which occupation would be a terrible fit for you?”, and a respondent who chooses “Professionals” over “Builders” in response to the prompt “Which occupation would be a terrible fit for you?” may be negatively associated with potential associations such as “office jobs”. Therefore, in an instance of the prompts and selectable responses table entry 142 associated with the prompt “Which occupation would be a terrible fit for you?” as shown in FIG. 8, the potential associations negatively associated with response 1 field 158 may store a representation of the potential association “office jobs”.

The prompts and selectable responses table entry 142 also includes a potential associations positively associated with response 2 field 160 that may store representations of any potential associations (stored in the potential associations store 130) that may be positively associated with a second selectable response to a prompt associated with an instance of the prompts and selectable responses table entry 142. For example, in the example of FIG. 6, “Energy & Utilities” may be a second selectable response, and a respondent who chooses “Energy & Utilities” over “Finance, Banking & Insurance” may be positively associated with potential associations such as “outdoors” and “manual labour”. Therefore, in an instance of the prompts and selectable responses table entry 142 associated with the prompt “Pick the industry sector you are more interested in.” as shown in FIG. 6, the potential associations positively associated with response 2 field 160 may store representations of potential associations “outdoors” and “manual labour”.

The prompts and selectable responses table entry 142 also includes a potential associations negatively associated with response 2 field 162 that may store representations of any potential associations (stored in the potential associations store 130) that may be negatively associated with a second selectable response to a prompt associated with an instance of the prompts and selectable responses table entry 142. For example, in the example of FIG. 8, “Builders” may be a second selectable response in response to the prompt “Which occupation would be a terrible fit for you?”, and a respondent who chooses “Builders” over “Professionals” in response to the prompt “Which occupation would be a terrible fit for you?” may be negatively associated with potential associations such as “outdoors” and “manual labour”. Therefore, in an instance of the prompts and selectable responses table entry 142 associated with the prompt “Which occupation would be a terrible fit for you?” as shown in FIG. 8, the potential associations negatively associated with response 2 field 162 may store representations of potential associations “outdoors” and “manual labour”.

The prompts and selectable responses table entry 142 also includes an answered field 164 that may store representations of when a prompt associated with an instance of the prompts and selectable responses table entry 142 has been answered.

Referring back to FIG. 2, the program memory 116 may include present prompts program codes 166 that, when executed by the microprocessor 114, cause the processor circuit 112 to control an interactive user interface of a user computing device (such as the user computing device 102 or 106) to present prompts (as shown in FIG. 5 to FIG. 11, for example) to a job applicant user, receive responses to the prompts from the job applicant user, and store the responses in a job applicant responses store 168 in the storage memory 118.

For example, where a prompt is associated with associated with two or more selectable responses, the present prompts program codes 166, when executed by the microprocessor 114, may cause the processor circuit 112 to control an interactive user interface of a user computing device (such as the user computing device 102 or 106) to cause a display screen, a video projector, or another output device of the user computing device to present text of the response (which may be retrieved from the text field 152 of an instance of the prompts and selectable responses table entry 142 associated with the prompt) and to present the selectable responses (which may be retrieved from the selectable responses field 154 of the instance of the prompts and selectable responses table entry 142 associated with the prompt) in respective selectable icons (as shown in FIG. 5 to FIG. 9, for example) or otherwise selectable. A selectable icon may also allow the user to skip the prompt, or the user may otherwise be presented with an option of skipping the prompt. Using one or more input devices of the user computing device, the user may select one of the selectable responses or skip the prompt, and at least one signal representing the user response (whether indicating selection of one of the selectable responses or skipping the prompt) may be transmitted from the user computing device to the network interface 122 (shown in FIG. 2).

Also, where a prompt is not associated with associated with two or more selectable responses, the present prompts program codes 166, when executed by the microprocessor 114, may cause the processor circuit 112 to control an interactive user interface of a user computing device (such as the user computing device 102 or 106) to cause a display screen, a video projector, or another output device of the user computing device to present text of the response (which may be retrieved from the text field 152 of an instance of the prompts and selectable responses table entry 142 associated with the prompt) and to present a space for the user to enter a response. Again, a selectable icon may also allow the user to skip the prompt, or the user may otherwise be presented with an option of skipping the prompt. Using one or more input devices of the user computing device, the user may enter a response or skip the prompt, and at least one signal representing the user response (whether indicating a response or skipping the prompt) may be transmitted from the user computing device to the network interface 122 (shown in FIG. 2).

Therefore, the processor circuit 112 may receive at least one input signal representing responses to prompts as described above. Further, because at least some responses may be selected from two or more selectable responses, responses selected from two or more selectable responses as stored in the job applicant responses store 168 may be structured data that may facilitate data processing more efficiently than other types of data such as unstructured data or data including natural-language responses.

Still referring to FIG. 2, the program memory 116 may include associate job applicants with job postings program codes 170 that, when executed by the microprocessor 114, cause the processor circuit 112 to associate job applicants, according to respective responses of the job applicants represented by storage codes stored in the job applicant responses store 168, with job postings represented by storage codes stored in the job postings store 134.

As indicated above, responses to prompts may be positively associated with one or more potential associations, negatively associated with one or more potential associations, or both. The responses of a job applicant, represented by storage codes stored in the job applicant responses store 168, may indicate a respective degree of association for each of one or more potential associations. The job postings program codes 170, when executed by the microprocessor 114, may cause the processor circuit 112 to count, for each potential association of one or more potential associations, a number of responses that are positively associated with the potential association, a number of responses that are negatively associated with the potential association, and a number of responses that could be positively or negatively associated with the potential association but were skipped.

For example, as indicated above, the potential associations “analytical” and “office jobs” may be positively associated with the selectable response “Finance, Banking & Insurance” in the example of FIG. 6. Therefore, when a user selects “Finance, Banking & Insurance” in the example of FIG. 6, a count of positive associations of the user with the potential associations “analytical” may increase by one, and a count of positive associations of the user with the potential associations “office jobs” may increase by one.

As another example, as indicated above, the potential associations “outdoors” and “manual labour” may be negatively associated with the selectable response “Builders” in the example of FIG. 8. Therefore, when a user selects “Builders” in the example of FIG. 8, a count of negative associations of the user with the potential associations “outdoors” may increase by one, and a count of negative associations of the user with the potential associations “manual labour” may increase by one.

As another example, as indicated above, the potential associations “analytical” and “office jobs” may be positively associated with the selectable response “Finance, Banking & Insurance” in the example of FIG. 6, and the potential associations “outdoors” and “manual labour” may be positively associated with the selectable response “Energy & Utilities” in the example of FIG. 6. Therefore, when a user skips the prompt in the example of FIG. 6, a count of skipped responses by the user in association with each of the potential associations “analytical”, “office jobs”, “outdoors”, and “manual labour” may increase by one.

The examples above illustrate positive and negative associations from selection of one from two or more selectable responses. However, as indicated above, in some cases, responses may allow a respondent to fill in a blank space. When responses are filled in, natural-language processing may identify positive or negative associations with one or more potential associations.

Following responses to prompts as described above, the job postings program codes 170, when executed by the microprocessor 114, may cause the processor circuit 112 to determine a degree of association of a user with a potential association as

$$\frac{{N}_{p} - {N}_{n}}{{N}_{p} + {N}_{n} + {N}_{s}}$$

where Nₚ is the count of the number of positive associations of the user with the potential association, Nₙ is the count of the number of negative associations of the user with the potential association, and Nₛ is the count of the number of skipped prompts by the user in association with the potential association. In other words, the job postings program codes 170, when executed by the microprocessor 114, may cause the processor circuit 112 to determine a degree of association of a user with a potential association in response to the count of the number of positive associations of the user with the potential association and in response to the count of the number of negative associations of the user with the potential association.

As also indicated above, the job postings represented by storage codes stored in the job postings store 134 may be associated with one or more potential associations that are desirable for job applicants for the job posting. For example,
1. a first job posting may be associated with the potential associations “creativity”, “health insurance”, and “architect”,
2. a second job posting may be associated with the potential associations “creativity”, “health insurance”, and “carpenter”,
3. a third job posting may be associated with the potential associations “creativity” and “health insurance”, and
4. a fourth job posting may be associated with the potential associations “creativity” and “carpenter”.

As also indicated above, for each user, job postings program codes 170, when executed by the microprocessor 114, may cause the processor circuit 112 to determine a degree of association of a user with one or more potential associations. Therefore, for example,
1. a first job applicant may have a degree of association of 0.5 for “creativity”, 0.2 for “health insurance”, 0.8 for “architect”, and 0.2 for “carpenter”,
2. a second job applicant may have a degree of association of 0.1 for “creativity”, 0.9 for “health insurance”, 0.2 for “architect”, and 0.8 for “carpenter”, and
3. a third job applicant may have a degree of association of 0.7 for “creativity”, 0.5 for “health insurance”, 0.8 for “architect”, and 0.3 for “carpenter”.

The job postings program codes 170, when executed by the microprocessor 114, may cause the processor circuit 112 to determine a degree of similarity of one or more potential associations of one or more job applicants with one or more potential associations of one or more job postings, for example by averaging the degrees of association of the user with the one or more potential associations associated with the job posting. For example,
1. the degree of similarity of the potential associations of first job applicant with the potential associations of first job posting may be the average of the degrees of association of the first job applicant with the potential associations associated with the first job posting, namely

$$\frac{0.5 + 0.2 + 0.8}{3} = 0.5 ,$$

2. the degree of similarity of the potential associations of first job applicant with the potential associations of second job posting may be the average of the degrees of association of the first job applicant with the potential associations associated with the second job posting, namely

$$\frac{0.5 + 0.2 + 0.2}{3} = 0.3 ,$$

3. the degree of similarity of the potential associations of second job applicant with the potential associations of first job posting may be the average of the degrees of association of the second job applicant with the potential associations associated with the first job posting, namely

$$\frac{0.1 + 0.9 + 0.2}{3} = 0.4 ,$$

and
4. the degree of similarity of the potential associations of second job applicant with the potential associations of second job posting may be the average of the degrees of association of the second job applicant with the potential associations associated with the second job posting, namely

$$\frac{0.1 + 0.9 + 0.8}{3} = 0.6 .$$

In general, such degrees of similarity may associate the job applicants with the job postings, and representations of such degrees of similarity may be stored in a job application association store 172 in the storage memory 118.

Further, the job postings program codes 170, when executed by the microprocessor 114, may cause the processor circuit 112 to rank job applicants with respect to job postings. For example, with respect to the first job posting, the first job applicant has a higher degree of similarity than the second job applicant, so the first job applicant would be ranked higher than the second job applicant. However, with respect to the second job posting, the second job applicant has a higher degree of similarity than the first job applicant, so the second job applicant would be ranked higher than the first job applicant.

Further, the job postings program codes 170, when executed by the microprocessor 114, may cause the processor circuit 112 to rank job postings with respect to job applicants. For example, with respect to the first job applicant, the first job posting has a higher degree of similarity than the second job posting, so the first job posting would be ranked higher than the second job posting. However, with respect to the second job applicant, the second job posting has a higher degree of similarity than the first job posting, so the second job posting would be ranked higher than the first job posting.

In general, such rankings may also associate the job applicants with the job postings, and representations of such rankings may also be stored in the job application association store 172.

The foregoing examples illustrate association of job applicants with job postings, but job applicants may similarly be associated with learning experiences. For example, the program memory 116 may include associate job applicants with learning opportunities program codes 174 that, when executed by the microprocessor 114, cause the processor circuit 112 to, similarly to the associate job applicants with job postings program codes 170 as described above, associate job applicants, according to respective responses of the job applicants represented by storage codes stored in the job applicant responses store 168, with learning opportunities represented by storage codes stored in the learning opportunities store 138. Representations of the associations of the job applicants with the learning opportunities may be stored in a learning opportunities association store 176 in the storage memory 118.

Also, the foregoing examples illustrate prompts to, and response by, job applicants, but employers learning institutions, and educators may also respond to prompts. The responses to prompts by employers, by learning institutions, and by educators may also influence how job applicants may be associated with employers or with learning opportunities.

In addition or alternatively to methods of association as described above, embodiments such as those described herein may involve use of artificial intelligence or machine-learning methods to associate job applicants with job postings, learning opportunities, or both. Artificial intelligence or machine-learning methods may consider responses to prompts as described above—whether prompts associated with selectable responses, prompts not associated with selectable responses but that rather allow a respondent to fill in a blank space (which may be analyzed using natural-language processing), or both—by job applicants, employers, learning institutions, educators, or two or more thereof, or other data, to associate job applicants with job postings, learning opportunities, or both.

Referring back to FIG. 3, a job applicant may respond to prompts (for example by selecting the “DESCRIBE YOURSELF” icon) as described above, view job postings that are ranked highest in respect of that user (for example by selecting the “TOP MATCHES” icon under “CAREER DISCOVERY”) as described above, and view learning opportunities that are ranked highest in respect of that user (for example by selecting the “TOP MATCHES” icon under “SKILL DISCOVERY”) as described above. For example, job applicants may view job postings that have a degree of similarity greater than a threshold (such as 0.7, for example).

Likewise, employers may view job applicants that are ranked highest in respect of each of one or more job postings. For example, employers may view job applicants that have a degree of similarity greater than a threshold (such as 0.7, for example).

Referring to FIG. 12, a job applicant may search jobs postings in other ways, for example by filtering key phrases in a title, job description, or organization name, by filtering by industry sector, by filtering by assignment period, by filtering by job trend, or by a combination of two or more thereof.

Referring to FIG. 13, a job applicant may search learning opportunities in other ways, for example by filtering key phrases in a program, credential, or organization, by filtering by credential offered, by filtering by maximum program cost, or by a combination of two or more thereof.

Referring to FIG. 14A and FIG. 14B, a job applicant may search learning opportunities in other ways, for example by selecting skills to gain.

Alternative embodiments may differ from the examples described above.

For example, in some embodiments, learning institutions or educators may review and analyze degrees of similarity with various different learning opportunities, which may allow learning institutions to determine what learning courses, learning programs including more than one learning course, skills, training, or other learning opportunities may be in demand, which may assist learning institutions or educators with planning what learning courses, learning programs including more than one learning course, skills, training, or other learning opportunities to offer. Embodiments such as those described herein may therefore provide a skills marketplace where job applicants or other individuals may be associated with learning opportunities that may facilitate improving the potential of such individuals.

Also, in some embodiments, job applicants, employers, learning institutions, educators, or two or more thereof may add new skills that may be associated with learning opportunities.

Also, in some embodiments, job applicants, employers, learning institutions, educators, or two or more thereof may add new potential associations to the potential associations store 130 to permit job postings, so that job postings or learning opportunities may be associated with new or additional potential associations.

Embodiments such as those described above involve responses that are selected from a plurality of selectable responses associated with a respective prompt. As indicated above, such responses may be stored as structured data that may facilitate data processing more efficiently than other types of data such as unstructured data or natural-language processing. Therefore, data processing as described above may improve efficiency of data processing and reduce required computing time when compared to other data-processing methods.

Further, embodiments such as those described above may facilitate improving or using the potential of individuals when compared to other data-processing methods. For example, embodiments such as those described above may facilitate matching job applicants with job postings more efficiently and in ways that may use the potential of individuals better than other data-processing methods. Further, embodiments such as those described above may facilitate matching job applicants with learning opportunities that may allow the job applicants to improve their potential more than from other data-processing methods. For example, when compared to data-processing methods that focus on industry-sector specialization, embodiments such as those described above may facilitate additional and more-personalized matching, for example by matching across more than one industry sector or matching with one or more learning opportunities.

Also, embodiments such as those described above may be more dynamic than other data-processing methods. For example, a job applicant may respond to a small number of prompts and consider job postings, learning opportunities, or both that may be associated with the job applicant based on such a small number of prompts, and the job applicant may choose to respond to further prompts to improve associations of the job applicant with job postings, learning opportunities, or both. In other words, associations of a job applicant with job postings, learning opportunities, or both may increase incrementally with increasing numbers of responses to prompts.

Also, embodiments such as those described above may associate a job applicant with job postings, learning opportunities, or both without requiring human intermediaries or intermediaries other than embodiments such as those described above. For example, according to embodiments such as those described above, job applicants may be associated with job postings, learning opportunities, or both without requiring human-resource consultants, recruiters, educational consultants, or other intermediaries.

Although specific embodiments have been described and illustrated, such embodiments should be considered illustrative only and not as limiting the invention as construed according to the accompanying claims.

1. A data-processing method comprising:
causing at least one computing device to receive at least one input signal representing at least a plurality of responses from at least one job applicant, each response of the plurality of responses being responsive to a respective prompt of a plurality of prompts, at least some responses of the plurality of responses selected from a plurality of selectable responses associated with the respective prompt;
causing the at least one computing device to, responsive to at least some of the plurality of responses from the at least one job applicant, associate the at least one job applicant with a respective at least one job posting; and
causing the at least one computing device to, responsive to at least some of the plurality of responses from the at least one job applicant, associate the at least one job applicant with a respective at least one learning opportunity.

2. The method of claim 1 further comprising causing the at least one computing device to cause at least some of the plurality of prompts to be presented to the at least one job applicant.

3. The method of claim 1 further comprising causing the at least one computing device to, responsive to at least some of the plurality of responses from the at least one job applicant, associate the at least one job applicant with a respective at least one potential association of a plurality of potential associations.

4. The method of claim 3 wherein causing the at least one computing device to associate the at least one job applicant with the respective at least one potential association comprises causing the at least one computing device to determine a respective degree of association of the at least one job applicant with each potential association of the respective at least one potential association.

5. The method of claim 4 wherein causing the at least one computing device to determine the respective degree of association of the at least one job applicant with each potential association of the respective at least one potential association comprises causing the at least one computing device to determine the respective degree of association of the at least one job applicant with each potential association of the respective at least one potential association responsive to at least a count of the plurality of responses from the at least one job applicant that are positively associated with the potential association.

6. The method of claim 4 wherein causing the at least one computing device to determine the respective degree of association of the at least one job applicant with each potential association of the respective at least one potential association comprises causing the at least one computing device to determine the respective degree of association of the at least one job applicant with each potential association of the respective at least one potential association responsive to at least a count of the plurality of responses from the at least one job applicant that are negatively associated with the potential association.

7. The method of claim 3 further comprising causing the at least one computing device to determine a degree of similarity of the respective at least one potential association associated with the at least one job applicant with a respective at least one potential association of the plurality of potential associations and associated with the at least one job posting, wherein causing the at least one computing device to associate the at least one job applicant with the at least one job posting comprises causing the at least one computing device to associate the at least one job applicant with the at least one job posting responsive to at least the degree of similarity of the respective at least one potential association associated with the at least one job applicant with the respective at least one potential association associated with the at least one job posting.

8. The method of claim 7 wherein:
causing the at least one computing device to associate the at least one job applicant with the respective at least one potential association comprises causing the at least one computing device to determine a respective degree of association of the at least one job applicant with each potential association of the respective at least one potential association; and
causing the at least one computing device to determine the degree of similarity of the respective at least one potential association associated with the at least one job applicant with the respective at least one potential association associated with the at least one job posting comprises causing the at least one computing device to determine the degree of similarity of the respective at least one potential association associated with the at least one job applicant with the respective at least one potential association associated with the at least one job posting comprises responsive to each respective degree of association of the at least one job applicant with the respective at least one potential association associated with the at least one job posting.

9. The method of claim 7 wherein causing the at least one computing device to associate the at least one job applicant with the at least one job posting comprises causing the at least one computing device to rank a plurality of job applicants comprising the at least one job applicant in association with the at least one job posting according to the respective degrees of similarity.

10. The method of claim 7 wherein causing the at least one computing device to associate the at least one job applicant with the at least one job posting comprises causing the at least one computing device to rank a plurality of job postings comprising the at least one job posting in association with the at least one job applicant according to the respective degrees of similarity.

11. The method of claim 3 further comprising causing the at least one computing device to determine a degree of similarity of the respective at least one potential association associated with the at least one job applicant with a respective at least one potential association of the plurality of potential associations and associated with the at least one learning opportunity, wherein causing the at least one computing device to associate the at least one job applicant with the at least one learning opportunity comprises causing the at least one computing device to associate the at least one job applicant with the at least one learning opportunity responsive to at least the degree of similarity of the respective at least one potential association associated with the at least one job applicant with the respective at least one potential association associated with the at least one learning opportunity.

12. The method of claim 11 wherein:
causing the at least one computing device to associate the at least one job applicant with the respective at least one potential association comprises causing the at least one computing device to determine a respective degree of association of the at least one job applicant with each potential association of the respective at least one potential association; and
causing the at least one computing device to determine the degree of similarity of the respective at least one potential association associated with the at least one job applicant with the respective at least one potential association associated with the at least one learning opportunity comprises causing the at least one computing device to determine the degree of similarity of the respective at least one potential association associated with the at least one job applicant with the respective at least one potential association associated with the at least one learning opportunity comprises responsive to each respective degree of association of the at least one job applicant with the respective at least one potential association associated with the at least one learning opportunity.

13. The method of claim 11 wherein causing the at least one computing device to associate the at least one job applicant with the at least one learning opportunity comprises causing the at least one computing device to rank a plurality of job applicants comprising the at least one job applicant in association with the at least one learning opportunity according to the respective degrees of similarity.

14. The method of claim 11 wherein causing the at least one computing device to associate the at least one job applicant with the at least one learning opportunity comprises causing the at least one computing device to rank a plurality of learning opportunities comprising the at least one learning opportunity in association with the at least one job applicant according to the respective degrees of similarity.

15. The method of claim 3 further comprising causing the at least one computing device receive at least one input signal representing a contribution, by the at least one job applicant, of at least one new potential association to the plurality of potential associations.

16. The method of claim 3 further comprising causing the at least one computing device receive at least one input signal representing a contribution, by at least one employer, of at least one new potential association to the plurality of potential associations.

17. The method of claim 3 further comprising causing the at least one computing device receive at least one input signal representing a contribution, by at least one learning institution, of at least one new potential association to the plurality of potential associations.

18. The method of claim 3 further comprising causing the at least one computing device receive at least one input signal representing a contribution, by at least one educator, of at least one new potential association to the plurality of potential associations.

19. The method of claim 1 wherein at least some of the plurality of potential associations are associated with respective different industry job trends.

20. The method of claim 1 wherein at least some of the plurality of potential associations are associated with respective different industry job sectors.

21. The method of claim 1 wherein at least some of the plurality of potential associations are associated with respective different occupations.

22. The method of claim 1 wherein at least some of the plurality of potential associations are associated with respective different employment benefits.

23. The method of claim 1 wherein at least some of the plurality of potential associations are associated with respective different skills.

24. The method of claim 1 wherein at least some of the plurality of potential associations are associated with respective social attributes.

25. The method of claim 1 wherein at least some of the plurality of potential associations are associated with respective social capabilities.

26. The method of claim 1 wherein at least some of the plurality of plurality of learning opportunities are respective different learning institutions.

27. The method of claim 26 wherein at least some of the learning institutions are provided independently from a provider of the method.

28. The method of claim 1 wherein at least some of the plurality of plurality of learning opportunities are respective different educators.

29. The method of claim 28 wherein at least some of the educators are independent from a provider of the method.

30. The method of claim 1 wherein at least some of the plurality of plurality of learning opportunities are respective different learning courses.

31. The method of claim 1 wherein at least some of the plurality of plurality of learning opportunities are respective different learning programs of respective pluralities of learning courses.

32. The method of claim 1 wherein at least some of the plurality of plurality of learning opportunities are respective different electronic media resources.

33. The method of claim 30 wherein at least some of the learning courses are provided independently from a provider of the method.

34. The method of claim 30 wherein at least some of the learning courses are provided by a provider of the method.

35. The method of claim 1 wherein causing the at least one computing device to associate the at least one job applicant with the respective at least one job posting comprises causing the at least one computing device to associate the at least one job applicant with the respective at least one job posting according to at least a machine-learning algorithm.

36. The method of claim 1 wherein causing the at least one computing device to associate the at least one job applicant with the respective at least one learning opportunity comprises causing the at least one computing device to associate the at least one job applicant with the respective at least one learning opportunity according to at least a machine-learning algorithm.

37. The method of claim 1 further comprising causing the at least one computing device to produce at least one output signal responsive to association of the at least one job applicant with the respective at least one job posting.

38. The method of claim 1 further comprising causing the at least one computing device to produce at least one output signal responsive to association of the at least one job applicant with the respective at least one learning opportunity.

39. At least one computer-readable medium storing thereon program codes that, when executed by at least one processor, cause the at least one processor to implement the method of claim 1.

40. At least one computing device programmed to implement the method of claim 1.

41. The method of claim 1 further comprising causing at least one user device to transmit the at least one input signal to the at least one computing device.

42. At least one computer-readable medium storing thereon program codes that, when executed by at least one processor, cause the at least one processor to implement the method of claim 41.

43. At least one computing device programmed to implement the method of claim 41.

44. The at least one computing device of claim 43 wherein the at least one computing device is or comprises a personal computer.

45. The at least one computing device of claim 43 wherein the at least one computing device is or comprises a laptop.

46. The at least one computing device of claim 43 wherein the at least one computing device is or comprises a tablet computer.

47. The at least one computing device of claim 43 wherein the at least one computing device is or comprises a smartphone.

48. The at least one computing device of claim 43 wherein the at least one computing device is or comprises a smart watch.

49. The at least one computing device of claim 43 wherein the at least one computing device is or comprises glasses.

50. The at least one computing device of claim 43 wherein the at least one computing device is or comprises a mobile activity tracker.

51. The at least one computing device of claim 43 wherein the at least one computing device is or comprises a wearable activity tracker.

52. The at least one computing device of claim 43 wherein the at least one computing device is or comprises a haptic glove.

53. The at least one computing device of claim 43 wherein the at least one computing device comprises at least one sensor wearable on a body and operable to measure movement of the body.

54. The method of claim 1 further comprising causing the at least one computing device to control an interactive user interface of a user computing device, wherein causing the at least one computing device to control the interactive user interface of the user computing device comprises causing the interactive user interface of the user computing device to, at least:
present the plurality of prompts;
receive the plurality of responses;
present the at least one job posting; and
present at least one identification of the at least one learning opportunity.
